(19) United States
(12) Patent Application Publication
(10) Pub. No.: US 2026/0062090 A1
(43) Pub. Date: Mar. 5, 2026

(54) STEERING ASSISTANCE FOR VEHICLES

(71) Applicant: TVS MOTOR COMPANY LIMITED, Chennai (IN)

(72) Inventors: Singhania Sharad, Chennai (IN); Manga Raju Karanam Venkata, Chennai (IN); S Makwana Avinash, Chennai (IN)

(73) Assignee: TVS MOTOR COMPANY LIMITED, Chennai (IN)

(21) Appl. No.: 19/101,666

(22) PCT Filed: Aug. 4, 2023
(86) PCT No.: PCT/IN2023/050752

§ 371 Date: Feb. 6, 2025

(30) Foreign Application Priority Data
Aug. 9, 2022 (IN) 202241045479

(51) Int. Cl. B62K 21/00; B62J 45/20; B62J 45/411; B62J 45/412; B62J 45/413; B62J 45/415

(52) U.S. Cl. CPC B62K 21/00; B62J 45/20; B62J 45/411; B62J 45/412; B62J 45/413; B62J 45/4151

(57) ABSTRACT

A system for providing steering assistance in a vehicle includes an electric motor and an Electronic Control Unit (ECU) electronically coupled to the electric motor. The ECU determines whether the vehicle is in a straight running state, a transient running state, or a steady cornering state. A first control signal is sent to the electric motor to set torque of the electric motor to a first value based on the determination that the vehicle is in the transient running state or the steady cornering state. A second control signal is sent to the electric motor to set torque of the electric motor to a second value based on the determination that the vehicle is in the straight running state.

### FIELD OF INVENTION

The present subject matter is related to, in general, vehicles and, in particular, steering assistance for vehicles.

### BACKGROUND

Generally, vehicles, such as four-wheelers, include Electric Power Assisted [symbol] and Electronic Stability Programme (ESP) for providing driving assistance to riders of the vehicle. For instance, the four-wheelers with EPAS or ESP provide a level-2 autonomy in driving of the vehicles. The vehicles can perform two autonomous tasks at a time, for example, a car can steer as well as perform lane-keeping, or auto-brake and operate adaptive cruise control.

Vehicles, such as two-wheelers, especially at low speeds, demonstrate relatively lesser stability or becomes instable. To balance the instability of the two-wheelers at low speeds, riders of the two-wheelers may have to provide continuous steering inputs. In particular, the two-wheelers are continuously steered by operating a handle bar, thereby operating a steering wheel (front wheel) of the two-wheelers. However, the riders have to exert a high force on the handle bar to maneuver the vehicles. Accordingly, it becomes extremely difficult for a rider to balance the vehicle as the vehicle has inherent poor stability at very low speeds. Therefore, the vehicles, such as two-wheelers, may roll over towards a lateral side, such as a left-hand side or a right-hand side of the two-wheelers.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a block diagram of a vehicle, in accordance with an implementation of the present subject matter;

FIG. 2 illustrates a general assembly of a frame of a vehicle, in accordance with an implementation of the present subject matter;

FIG. 3a illustrates a top view of a gear box assembly of an actuator assembly of a vehicle, in accordance with an implementation of the present subject matter;

FIG. 3b illustrates an exploded view of a gear box assembly of an actuator assembly of a vehicle, in accordance with an implementation of the present subject matter; and

FIG. 4 illustrates a method for providing steering assistance to the vehicles, in accordance with an implementation of the present subject matter.

### SUMMARY

In accordance with an example implementation, a system for providing steering assistance in a vehicle may include an actuator assembly. The vehicle may be, for example, a two-wheeler, or a three-wheeler. The actuator assembly may include an electric motor to provide torque to a steering assembly of the vehicle. In an example, the actuator assembly may include a gear box assembly coupled to the electric motor to enhance the torque from the electric motor that is to be provided to the steering assembly. The steering assembly of the vehicle enables manoeuvring of the vehicle. In an example, the actuator assembly may be disposed on the steering assembly of the vehicle. The system may include an Electronic control Unit (ECU) electronically coupled to the electric motor. The ECU may be, for example, the ECU that is to control the functioning of the vehicle. The ECU may determine if the vehicle is riding in a straight running state, a transient running state, or a steady cornering state. The straight running state may be a riding condition in which the vehicle may be riding along a straight path minimal manoeuvring or without manoeuvring. The transient running state may be a riding condition in which the rider transiently maneuvers the vehicle, for example, during traffic conditions, or when the rider tries to evade a pothole or a road disturbance suddenly. The steady cornering state may be a riding condition in which the vehicle may take a turning path.

Based on the determination that the vehicle is in the transient running state or the steady cornering state, the ECU may send a first control signal to the electric motor to set torque of the electric motor to a first value. The first value may be dependent on a first non-linear gain value and a steering torque of the vehicle. The steering torque may correspond to torque that is being applied on a steering assembly of the vehicle by a rider. The first non-linear gain value may be dependent on speed of the vehicle, weight of the vehicle, layout of the vehicle, mass-distribution of the vehicle, the steering torque, and an estimated steering torque. The estimated steering torque may be a torque that is to be applied on the steering assembly of the vehicle to balance the vehicle.

Based on the determination that the vehicle is in the straight line riding state, the ECU may send a second control signal to the electric motor to set torque of the electric motor to a second value. The second value may be dependent on a second non-linear gain value, a third non-linear gain value, an angular displacement of the vehicle, and an angular velocity of the vehicle. The second non-linear gain value and the third non-linear gain value may be dependent on the speed of the vehicle, the weight of the vehicle, the layout of the vehicle, and the mass-distribution of the vehicle.

### DETAILED DESCRIPTION

Existing two-wheelers demonstrate relatively lesser stability or becomes instable, especially at low speeds. To overcome the instability, the riders of the two-wheelers may have to continuously steer by operating a handle bar, thereby operating a steering wheel (front wheel) of the two-wheelers. However, the riders may have to exert a high force on the handle bar and thereby, making it extremely difficult for riders to balance the two-wheelers. Therefore, the two-wheelers may roll over towards a lateral side, such as a left-hand side or a right-hand side of the two-wheelers. Further, such riding causes discomfort and fatigue for the riders.

In some scenarios, an electric motor is provided for providing steering assistance to the vehicle. The electric motor may provide the inputs similar to rider to balance the two-wheelers. However, the torque for balancing the two-wheelers, especially at low speeds, is high. Therefore, an electric motor that is to directly provide high amount of torque may be heavy. The usage of heavy electric motors in two-wheelers may increase the load on the two-wheelers and thereby, affecting the dynamics of the two-wheelers. Further, such motors for providing steering inputs will be expensive and thereby, increases the cost of the two-wheelers.

The present subject matter relates to steering assistance for vehicles. With the implementations of the present subject matter, the vehicles, such as two-wheelers, can be balanced even at low-speeds without much effort from the rider. Further, the present subject matter provides steering assistance to the vehicles without the usage of heavy and expensive motors.

In accordance with an example implementation, a system for providing steering assistance in a vehicle may include an actuator assembly. The vehicle may be, for example, a two-wheeler, or a three-wheeler. The actuator assembly may include an electric motor to provide torque to a steering assembly of the vehicle. In an example, the actuator assembly may include a gear box assembly coupled to the electric motor to enhance the torque from the electric motor that is to be provided to the steering assembly. The steering assembly of the vehicle enables manoeuvring of the vehicle. In an example, the actuator assembly may be disposed on the steering assembly of the vehicle. The system may include an Electronic control Unit (ECU) electronically coupled to the electric motor. The ECU may be, for example, the ECU that is to control the functioning of the vehicle. The ECU may determine if the vehicle is riding in a straight running state, a transient running state, or a steady cornering state. The straight running state may be a riding condition in which the vehicle may be riding along a straight path minimal manoeuvring or without manoeuvring. The transient running state may be a riding condition in which the rider transiently maneuvers the vehicle, for example, during traffic conditions, or when the rider tries to evade a pothole or a road disturbance suddenly. The steady cornering state may be a riding condition in which the vehicle may take a turning path.

Based on the determination that the vehicle is in the transient running state or the steady cornering state, the ECU may send a first control signal to the electric motor to set torque of the electric motor to a first value. The first value may be dependent on a first non-linear gain value and a steering torque of the vehicle. The steering torque may correspond to torque that is being applied on a steering assembly of the vehicle by a rider. The first non-linear gain value may be dependent on speed of the vehicle, weight of the vehicle, layout of the vehicle, mass-distribution of the vehicle, the steering torque, and an estimated steering torque. The estimated steering torque may be a torque that is to be applied on the steering assembly of the vehicle to balance the vehicle. In an example, the ECU may determine the first value of the vehicle and the estimated steering torque of the vehicle. Further, the ECU may receive the steering torque from a steering torque sensor.

Based on the determination that the vehicle is in the straight line riding state, the ECU may send a second control signal to the electric motor to set torque of the electric motor to a second value. The second value may be dependent on a second non-linear gain value, a third non-linear gain value, an angular displacement of the vehicle, and an angular velocity of the vehicle. The second non-linear gain value and the third non-linear gain value may be dependent on the speed of the vehicle, the weight of the vehicle, the layout of the vehicle, and the mass-distribution of the vehicle. In an example, the ECU may determine the second value. Further, the angular displacement and the angular velocity may be angular displacement along a longitudinal direction of the vehicle and angular velocity along a longitudinal direction of the vehicle.

The present subject matter provides improved riding experience to the riders by providing steering assistance to the vehicles. In the present subject matter, the vehicles, such as two-wheelers, can be balanced even at low-speeds without much effort from the rider. Therefore, the riders can comfortably ride in different riding conditions, such as straight running state, transient running state, and steady cornering state. The present subject matter can provide balancing assistance to the vehicle, in conditions where the vehicle is riding in a straight line and power assistance to the vehicle in conditions where the vehicle is riding in transient running state or steady cornering state. Further, the present subject matter reduces fatigue of the rider while driving the vehicle at low-speeds and prevents rolling of the vehicle due to instability.

In the present subject matter, a gear box assembly is provided to enhance the torque provided by the electric motor to the steering assembly of the vehicle. Therefore, the present subject matter provides steering assistance to the vehicles without the usage of heavy and expensive electric motors. In the present subject matter, the actuator assembly is disposed in the vehicle such that there is minimal or no impact on dynamics of the two-wheeler. Further, the torque provided by the rider on the steering assembly while riding the vehicle is taken into account while providing steering assistance to the vehicle. Therefore, the present subject matter eliminates the scenarios where the torque provided by the rider on the steering assembly and the torque provided by the actuator assembly interferes with each other, and thereby, providing excess torque than that is required to balance the steering assembly of the vehicle. Accordingly, the present subject matter prevents rolling over of the vehicle or instability of the vehicle caused due to excess torque being applied on the steering assembly due to such scenarios.

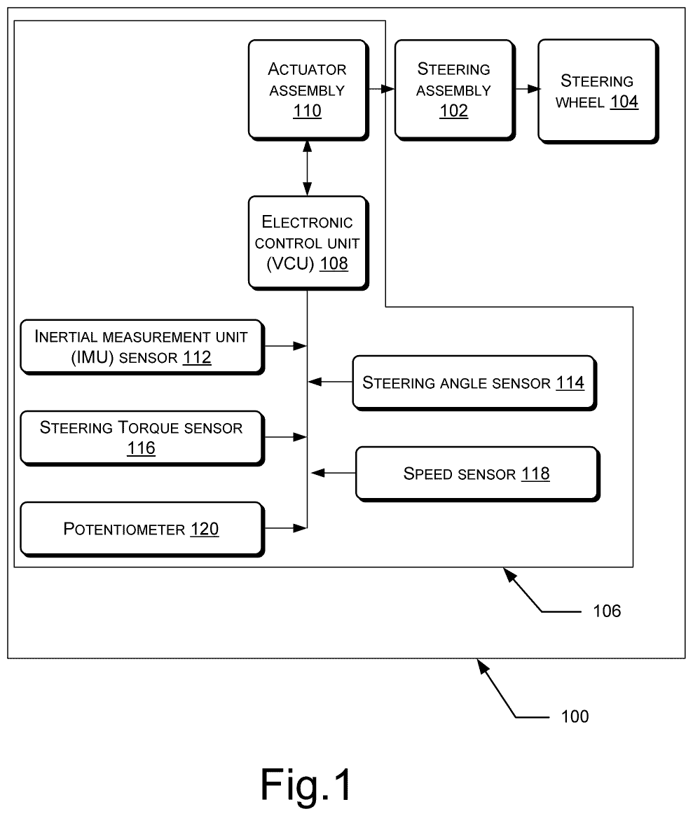

The present subject matter is further described with reference to FIGS. 1-4. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of a vehicle 100, in accordance with an implementation of the present subject matter. The vehicle 100 may be, for example, a two-wheeler or a three-wheeler. Hereinafter, the vehicle 100 may be explained with reference to a two-wheeler. The vehicle 100 may include a frame (not shown in FIG. 1) that is to provide structural support to the load acting on the vehicle 100. The vehicle 100 may include a steering assembly 102 to manoeuvre the vehicle 100. A rider (not shown in FIG. 1) may control the steering assembly 102 to control manoeuvre of the vehicle 100. In an example, the vehicle 100 may include a steering wheel 104 that is coupled to the steering assembly 102. The steering assembly 102 may drive the steering wheel 104 to manoeuvre the vehicle 100. The steering wheel 104 may be, for example, the front wheel of the vehicle 100.

The vehicle 100 may include a SAS 106 that is to provide steering assistance to the rider of the vehicle 100. The SAS 106 may be referred to as the steering assistance SAS 106 (SAS). The SAS 106 may include an electronic control unit (ECU) 108 to control functioning of the vehicle 100. In an example, the ECU 108 may control the functioning of the vehicle 100. In an example, the ECU 108 may control various components through the corresponding control unit. For instance, the ECU 108 transmit a signal to a Transmission Control Unit (TCU) (not shown in FIG. 1) to control the functioning of a transmission assembly (not shown in FIG. 1) of the vehicle 100.

The SAS 106 may include an actuator assembly 110 may provide actuating force, i.e., torque to the steering assembly 102, for providing steering assistance to the rider. The actuator assembly 110 may be disposed on the frame and coupled to the steering assembly 102. In an example, the actuator assembly 110 may include an electric motor (not shown in FIG. 1). The electric motor may be coupled to the ECU 108 and to the steering assembly 102. The electric motor may provide torque to the steering assembly 102. In an example, the torque that is to balance the vehicle 100 in scenarios, where the vehicles experience instability, is high. Therefore, the electric motor that is to provide torque may have to be heavy and expensive. However, to overcome the usage of heavy and an expensive electric motor, the actuator assembly 110 may include a gear box assembly (not shown in FIG. 1) that is coupled to the electric motor and to the steering assembly 102. The gear box assembly may enhance the torque produced by the electric motor and provides an enhanced torque to the steering assembly 102. Therefore, the use of the gear box assembly to provide enhanced torque prevents use of heavy and expensive electric motor.

The SAS 106 may include a plurality of sensors, such as a first sensor 112, a second sensor 114, a third sensor 116, a fourth sensor 118, and a fifth sensor 120. The sensors 112-120 may enable collecting various parameters to provide steering assistance to the vehicle 100. Each of the plurality of sensors may be communicatively coupled to the ECU 108 in order to provide various dynamic operating conditions of the vehicle 100. In an example, the first sensor 112 may be an Inertial Measurement Unit (IMU) sensor. Hereinafter, the first sensor 112 may be explained with reference to the IMU sensor 112. The IMU sensor 112 may determine an angular displacement and an angular velocity of the vehicle 100. In particular, the IMU sensor 112 may determine the angular displacement along a longitudinal direction of the vehicle 100 and the angular velocity along the longitudinal direction of the vehicle 100. The angular displacement along the longitudinal direction of the vehicle 100 is referred to as the roll angle of the vehicle 100. The angular velocity along the longitudinal direction of the vehicle 100 is referred to as the roll velocity of the vehicle 100.

The second sensor 114 may be, for example, one of a steering angle sensor and a steering torque sensor. The third sensor 116 may be, for example, another of the steering angle sensor and the steering torque sensor. Hereinafter, the second sensor 114 will be explained with reference to the steering angle sensor and the third sensor 116 will be explained with reference to the steering torque sensor. The steering angle sensor 114 may determine the steering angle of the vehicle 100 and the steering torque sensor 116 may determine the steering torque of the vehicle 100. The steering angle may correspond to an angle to which the steering assembly 102 is displaced. The steering torque may correspond to torque that is being applied on the steering assembly 102.

The fourth sensor 118 may be, for example, a speed sensor. Hereinafter, the fourth sensor will be explained with reference to the speed sensor. The speed sensor 118 may determine the speed of the vehicle 100. In an example, the speed sensor 118 may be Global Positioning System (GPS) sensor. The fifth sensor 120 may be, for example, a potentiometer. Hereinafter, the fifth sensor 120 will be explained with reference to the potentiometer. The potentiometer 120 may be coupled to the electric motor to determine the displacement (torque) of the electric motor.

The vehicle 100 may include a vehicle bus (not shown in FIG. 1) for enabling communication among various components of the vehicle 100, such as the ECU 108 and the sensors. The vehicle bus may be, for example, Control Area Network (CAN) bus, or the like.

In operation, the ECU 108 may determine if the vehicle 100 is riding in a straight running state, a transient running state, or a steady cornering state. The straight running state may be a riding condition in which the vehicle 100 may be riding along a straight path minimal manoeuvring or without manoeuvring. The transient running state may be a riding condition in which the rider transiently manoeuvres the vehicle 100, for example, during traffic conditions, or when the rider tries to evade a pothole or a road disturbance suddenly. The steady cornering may be a riding condition in which the vehicle 100 may take a turning path.

Based on the determination that the vehicle 100 is in the transient running state or the steady cornering state, the ECU 108 may send a first control signal to the electric motor to set torque of the electric motor to a first value. The first value may be dependent on a first non-linear gain value and a steering torque of the vehicle 100. The first non-linear gain value may be dependent on speed of the vehicle 100, weight of the vehicle 100, layout of the vehicle 100, mass-distribution of the vehicle 100, the steering torque, and an estimated steering torque. The estimated steering torque may be a torque that is to be applied on the steering assembly 102 to balance the vehicle 100. In an example, the ECU 108 may determine the first value of the vehicle 100 and the estimated steering torque of the vehicle 100. Further, the ECU 108 may receive the steering torque from the second sensor or the third sensor.

Based on the determination that the vehicle 100 is in the straight line riding state, the ECU 108 may send a second control signal to the electric motor to set torque of the electric motor to a second value. The second value may be dependent on a second non-linear gain value, a third non-linear gain value, an angular displacement of the vehicle 100, and an angular velocity of the vehicle 100. The second non-linear gain value and the third non-linear gain value may be dependent on the speed of the vehicle 100, weight of the vehicle 100, the layout of the vehicle 100, the mass-distribution of the vehicle 100. In an example, the ECU 108 may determine the second value. Further, the angular displacement and the angular velocity may be the roll angle and the roll rate respectively. Hereinafter, the angular displacement may be explained with reference to roll angle and the angular velocity may be explained with reference to roll rate. The ECU 108 may receive the roll angle and the roll rate from the IMU 112.

In an example, to determine if the vehicle 100 is in the straight riding state, the transient running state, or the steady cornering state, the ECU 108 may compare the roll angle with a threshold roll angle. Further, the ECU 108 may compare the steering angle with a threshold steering angle. Based on the comparison, the ECU 108 may determine that the vehicle 100 is in the straight riding state if the roll angle is less that threshold roll angle and the steering angle of the steering assembly 102 is less than the threshold steering angle of the steering assembly 102. Further, the ECU 108 may determine that the vehicle 100 is in the transient running state or the steady cornering state, if the roll angle is greater that threshold roll angle and the steering angle is greater than the threshold steering angle.

In some examples, upon the determination that the vehicle 100 is in the transient running state or the steady cornering state, the ECU 108 may compare the steering torque of the vehicle 100 with a threshold steering torque of the vehicle 100. Further, the ECU 108 may send the first control signal to the electric motor, if the steering torque is greater than the threshold steering torque and send a third control signal to the electric motor to set torque of the electric motor to zero, if the steering torque is less than the threshold steering torque.

In some examples, upon sending the first control signal, the second control signal, or the third control signal, the ECU 108 may receive the displacement (torque) of the electric motor. Based on the receipt, the ECU 108 may determine if the torque of the electric motor is same as the control signal provided to the electric motor by the ECU 108. For instance, if the first control signal is sent to the electric motor, the ECU may determine if the torque of the electric motor is the first value. Similarly, if the second control signal is sent to the electric motor, the ECU may determine if the torque of the electric motor is the second value and if the third control signal is sent to the electric motor, the ECU may determine if the torque of the electric motor is zero. This may ensure that there is no additional or lesser torque provided to the electric motor to the ECU 108. In response to the determination, the ECU 108 may resend the control signal or send a new control signal if current torque of the electric motor and the torque of the electric motor that is set by the ECU 108 are different. On the other hand, if current torque of the electric motor and the torque of the electric motor that is set by the ECU 108 are same, the ECU 108 may refrain from sending a new control signal or resending the control signal. Therefore, the use of the potentiometer 120 in the vehicle 100 ensures that the sufficient torque (neither higher torque nor lesser torque) is provided to the steering assembly 102.

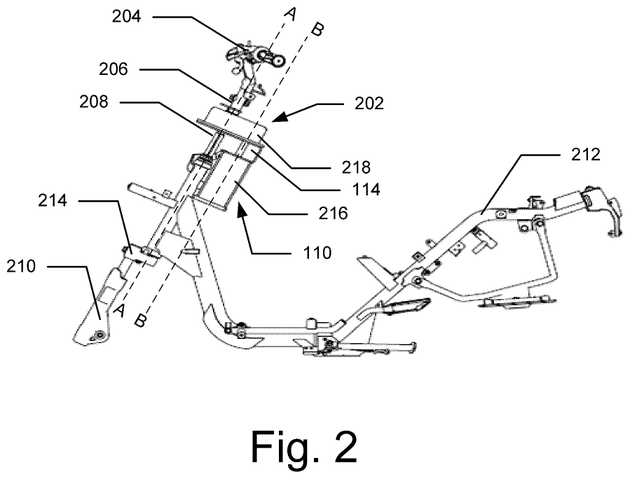

FIG. 2 illustrates a general assembly of the frame 202 of the vehicle 100, in accordance with an implementation of the present subject matter. The frame 202 may include a handle bar 204, a head tube 206, and a steering column 208. The handle bar 204 may enable maneuvering of the vehicle 100 by the rider. The handle bar 204 may be connected to the steering column 208 by the head tube 206. The handle bar 204 may support a plurality of components, such as an instrument cluster (not shown in FIG. 2), throttle (not shown in FIG. 2), clutch (not shown in FIG. 2), or electrical switches (not shown in FIG. 2). The steering column 208 may be rotatably journaled about the head tube 206 and may extend downward from the head tube 206. The steering column 208 may be coupled to the steering wheel 104 (the front wheel) (not shown in FIG. 2) through a front suspension system 210. The steering column 208 may control steering movement of the vehicle 100 by transferring the torque provided by the rider on the handle bar 204 to the front wheel 104. Further, the frame 202 may include one or more rear tubes 212 extending inclinedly rearward from the steering column 208. The front wheel 104 may be rotatably supported by the front suspension system 210 and a rear wheel (not shown in FIG. 2) may be rotatably supported by a rear suspension system (not shown in FIG. 2).

The vehicle 100 may include other components, such as a power source, a transmission assembly, a seat assembly, and the like, which are not shown or described herein for the sake of brevity. Further, the vehicle 100 may include a plurality of panels (not shown in FIG. 2) mounted to the frame 202 and covering the frame 202 assembly and/or parts of the vehicle 100.

The SAS 106 is supported on the frame 202. The frame 202 may include a lower bridge 214 that is connected to a lower end of the steering column 208. The lower bridge 214 may support the front suspension system 210. The steering column 208 is rotatable about a central axis A-A passing through centre of the steering column 208. The central axis A-A passing through centre of the steering column 208 may be referred to as the steering axis. The actuator assembly 110 may include the electric motor and the gear box assembly 218. The gear box assembly 218 may be connected to the electric motor 216. The electric motor 216 and the gear box assembly 218 may be fixedly mounted to the frame 202. In particular, the electric motor 216 and the gear box assembly 218 may be fixedly mounted to a portion of the frame 202 that includes both the head tube 206 and the steering column 208. particularly, the gear box assembly 218 may be fixed to the head tube 206. The electric motor 216 may be disposed to extend from the gear box assembly 218 downwards and extends across a portion of the head tube 206 and a portion of the steering column 208.

In an example, the steering axis A-A may be parallel to an axis B-B passing through a centre of the electric motor 216. The axis B-B passing through the centre of the electric motor 216 may be referred to as the motor axis. In the vehicle 100, to accommodate the actuator assembly 110, an existing configuration of the head tube 206 can be retained in the vehicle 100, without the need for changing a front portion (for example, the head tube 206 portion) of the frame 202. The gear box assembly 218 and the electric motor 216 may be disposed substantially at a laterally central region of the vehicle 100 and are mounted in a balanced manner on the vehicle 100 without shifting center of gravity of the vehicle 100 towards any lateral sides, such as left-hand side of the vehicle 100 or right-hand side of the vehicle 100. Also, the configuration of the gear box assembly 218 unit as well as the electric motor 216 enables mass centralization closer to the steering axis A-A thereby minimizing change in steering inertia and enabling enhanced handling stability of the vehicle 100.

In an example, the sensors 112-120 are coupled to the frame 202. The steering angle sensor 114 and the steering torque sensor 116 (not shown in FIG. 2) may be mounted between the actuator assembly 110 and the steering column 208. Thus, the steering angle sensor 114 and the steering torque sensor 116 are disposed securely, thereby achieving a compact and stable layout. The steering angle sensor 114 and the steering torque sensor 116 may be coupled to the gear box assembly 218. The steering angle sensor 114 and the steering torque sensor 116 may be compactly accommodated on the vehicle 100 without disturbing the function of the steering column 208, the electric motor 216 and the handle bar 204. The steering torque sensor 116 may be mounted in the steering column 208.

In an example, the ECU 108 may be supported by the rear tubes 212. The ECU 108 may be communicatively coupled to the electric motor 216 in order to activate/deactivate or control operation of the electric motor 216.

The IMU sensor 112 (not shown in FIG. 2) may be supported by the frame 202. In an example, the IMU sensor 112 may be disposed at the posterior region of the vehicle 100 and substantially in close vicinity of the ECU 108 to enable a compact and secure layout of the vehicle 100. The speed sensor 118 (not shown in FIG. 2) may also be supported by the frame 202.

As mentioned earlier, the gear box assembly 218 enhances the torque provided by the electric motor 216. The torque output from the electric motor 216 is enhanced through a desired gear ratio of the gear box assembly 218. Since the gear box assembly 218 is used to enhance the torque, a small electric motor 216 can be used for providing torque to the steering column 208. Thus, need for a large electric motor 216 to produce higher torque is avoided. Accordingly, a battery with a small capacity may be sufficient to operate the electric motor 216, thereby avoiding a large capacity battery power. The battery with small capacity can be accommodated in the vehicle 100 without the need for any change in layout of the vehicle 100. Therefore, the vehicle 100 has a compact configuration and cost advantage due to retainment of conventional design of the vehicle 100 & use of a small motor.

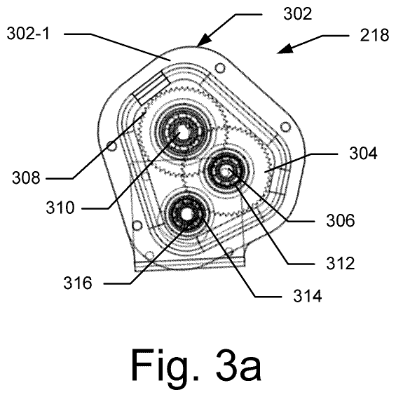

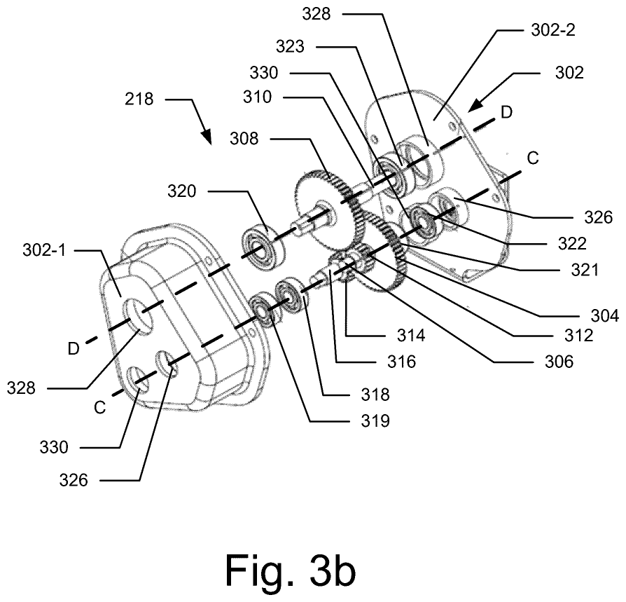

FIG. 3a illustrates a top view of the gear box assembly 218 of the actuator assembly 110 of the vehicle 100, in accordance with an implementation of the present subject matter. FIG. 3b illustrates an exploded view of a gear box assembly 218 of the actuator assembly 110 of the vehicle 100, in accordance with an implementation of the present subject matter. For the sake of brevity, FIGS. 3a-3b are explained in conjunction with each other. The gear box assembly 218 may include a housing 302 formed by a first casing 302-1 and a second casing 302-2. The first casing 302-1 and the second casing 302-2 may define a volume in which a plurality of gears are enclosed. For instance, a drive gear 304 is rotatably supported on a drive shaft 306. The electric motor 216 may be coupled to the drive gear 304 and the drive shaft 306. The drive gear 304 may be meshed with and may drive a driven gear 308. The driven gear 308 may be supported on a driven shaft 310. The driven gear 308 may be coupled to the handle bar 204 through the steering column 208. One end of the driven shaft 310 may be coupled to the steering column 208 and another end of the driven shaft 310 may be coupled to the handle bar 204. A gear ratio between the drive gear 304 and the driven gear 308 may provide enhanced torque to the steering column 208. The gear ratio may be chosen so as to ensure that the sufficient torque is provided to the steering column 208 upon receiving the torque from the electric motor 216. An axis C-C of rotation of the drive gear 304 and an axis D-D of rotation of the driven gear 308 are may be parallel to each other. The drive gear 304 may be meshed to the electric motor 216 and the driven gear 308 may be meshed to the steering column 208. In an example, the drive gear 304 is smaller (i.e., having a lesser number of teeth) when compared with the driven gear 308.

Further, the gear box assembly 218 may include a tandem gear 312. The tandem gear 312 may be attached to the drive shaft 306 same as that of the drive gear 304. The tandem gear 312 may be meshed with a gear sensor 314, which is configured to functionally interface with the steering angle sensor 114 and/or the steering torque sensor 116 to provide steering angle of the steering column 208. The steering angle sensor 114 and the steering torque sensor 116 may also provide steering angle or steering torque of the electric motor 216. The gear sensor 314 may be rotatably supported on a sensor shaft 316. The shafts 306, 310, 316 may be rotatably supported in the gear box assembly 218 through a plurality of bearings 318, 319, 320, 321, 322, 323. The first casing 302-1 and the second casing 302-2 may be provided with slots 324, 326, 328 to support the bearings 318-323. In an example, the diameter of the gears 304, 308, 312, 314, diameter of the bearings 318-323, diameter of the casings 302-1, 302-2, the number of the gear tooth of the gears 304, 308, 312, 314, the height of the gears 304, 308, 312, 314, bearings 318-323, and the casings 302-1, 302-2 may be chosen so as to ensure gear ratio sufficient to provide required torque enhancement, the gear box assembly 218 is compact. Accordingly, in an example, the gear box assembly 218 may have a small height and a small width. Therefore, the gear box assembly 218 may be compactly positioned in the steering assembly 102.

During operation, when the electric motor 216 rotates, a shaft of the electric motor 216 may transfer the torque to the drive shaft 306. The drive shaft 306 may rotate, thereby causing rotation of the of the drive gear 304. The rotation of the drive gear 304 causes rotation of the driven gear 308, thereby causing rotation of the driven shaft 310. The torque with which the driven shaft 310 rotates is increased due to the gear ratio between the drive shaft 306 and the driven shaft 310. The increase torque of the driven shaft 310 may then be transferred to the steering column 208. The increased torque provided to the steering column 208 may be transferred to the front wheel to provide steering assistance to the rider.

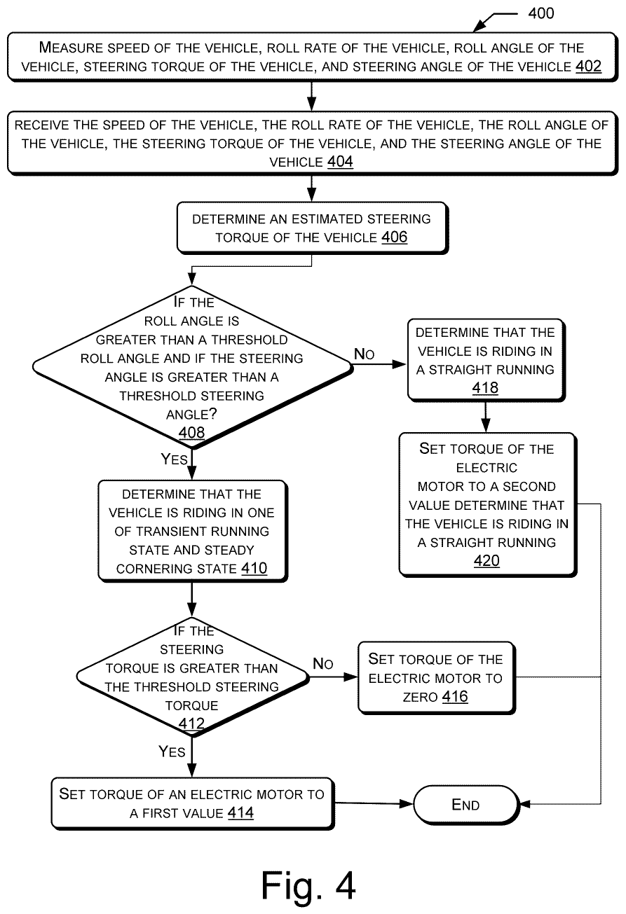

FIG. 4 illustrates a method for providing steering assistance to the vehicle 100, in accordance with an implementation of the present subject matter. The order in which the method 400 is described is not intended to be construed as a limitation, and any number of the described method blocks may be combined in any order to implement the method 400 or an alternative method. Furthermore, the method 400 may be implemented by processor(s) or computing device(s) through any suitable hardware, non-transitory machine-readable instructions, or a combination thereof. The method 400 may be utilized in the vehicle 100. In particular, the method 400 may be performed by the SAS 106.

At block 402, the speed of the vehicle 100, the roll rate of the vehicle 100, the roll angle of the vehicle 100, the steering torque of the vehicle 100, and the steering angle of the vehicle 100 may be measured. The first sensor (the IMU sensor 112) may determine the roll angle and the roll rate of the vehicle 100. The second sensor and the third sensor (the steering torque sensor 116 or the steering angle sensor 114) may determine the steering torque of the vehicle 100 and the steering angle of the vehicle 100. Further, the fourth sensor (the speed sensor 118) may determine the speed of the vehicle 100.

At block 404, the speed, the roll rate, the roll angle, the steering torque, and the steering angle may be received. For instance, the ECU 108 may receive the parameters from the corresponding sensors. At block 406, the ECU 108 may determine an estimated steering torque. The estimated steering torque may be torque to be supplied to the steering assembly 102 of the vehicle 100. That is, the estimated steering torque is the total amount of torque required for the steering assembly 102 so that the vehicle 100 is stable.

The SAS 106 may have to determine the running state of the vehicle 100 to provide the steering assistance accordingly. Therefore, at block 408, the ECU 108 may compare the roll angle with a threshold roll angle and compare steering angle with a threshold steering angle to determine if the vehicle 100 is in the straight running state, the transient running state, and the steady cornering state. In an example, the ECU 108 may compare an instantaneous roll angle with the threshold roll angle. The instantaneous roll angle may be the roll angle of the vehicle 100 at a single instance of time. However, in some examples, the ECU 108 may compare an average roll angle with the threshold roll angle. The average roll angle may be the roll angle of the vehicle 100 taken over a period of time, for instance, over previous 5 seconds of travel of the vehicle 100.

If the roll angle is greater than the threshold roll angle and the steering angle is greater than the threshold steering angle, at block 410, the ECU 108 may determine that the vehicle 100 is in the transient running state or the steady cornering state. Subsequently, upon the determination that the vehicle 100 is in one of the transient running state or the steady cornering state, at block 412, the ECU 108 may compare the steering torque of the vehicle 100 with a threshold steering torque of the vehicle 100.

If it is determined that the steering torque is greater than the threshold steering torque, at block 414, the ECU 108 may send the first control signal to the electric motor 216 to the first value. In an example, prior to the sending the first control signal, the ECU 108 may estimate the first value. The first value may be dependent on the first non-linear gain value and the steering torque. In particular, the first value may be a product of the first non-linear gain value and the steering torque, as is shown in the below equation (1)

$$Torque value of the motor = A * {T}_{st} \qquad ( 1 )$$

A is the first non-linear gain value and Tₛₜ is the steering torque. The first non-linear gain value may be dependent on the speed of the vehicle 100, the weight of the vehicle 100, the layout of the vehicle 100, the mass-distribution of the vehicle 100, the steering torque, and an estimated steering torque. In an example the first non-linear gain value may be estimated by the ECU 108 using the below equation (2)

$$A = sign ( Torque sensor reading ) * ( z 1 + ( ( z 2 - 1 ) / z 2 ) * abs ( Torque sensor reading ) ) - Estimated steering torque \qquad ( 2 )$$

where abs indicates absolute value without considering the sign of the value. Further, Z is a constant value and is dependent on the speed of the vehicle 100 and the vehicle 100 specifications, such as the weight of the vehicle 100, the layout of the vehicle 100, the mass-distribution of the vehicle 100, the steering torque, and an estimated steering torque. If the steering torque is less than the threshold steering torque, at block 416, the ECU 108 may send a third control signal to the electric motor 216 to set torque of the electric motor 216 to zero.

Referring back to block 408, If the roll angle is less than the threshold roll angle and the steering angle is less than the threshold steering angle, the ECU 108 may determine, at block 418, that the vehicle 100 is in the straight running state.

Subsequently, at block 420, based on the determination that the vehicle 100 is riding in the straight running state, the ECU 108 may send the second control signal to the electric motor 216 to set torque of the electric motor 216 to the second value. Prior to sending the second control signal, the ECU 108 may estimate the second value. The second value may be dependent on the second non-linear gain value, the roll rate, the third non-linear gain value, and the roll angle. The ECU 108 may estimate the second value as a sum of product of the second non-linear gain value and a roll rate of the vehicle 100 and a product of the third non-linear gain value and a roll angle of the vehicle 100, as per the below equation (3)

$$Torque value of the motor = B * φ ( t ) + C * \dot{φ} ( t ) \qquad ( 3 )$$

B is the second non-linear gain value, C is the third non-linear gain value, φ(t) is the roll angle of the vehicle 100 and \dot{φ}(t) is the roll rate of the vehicle 100. The second non-linear gain value and the third non-linear gain value are dependent on the speed of the vehicle 100, the weight of the vehicle 100, the layout of the vehicle 100, mass-distribution of the vehicle 100. The second non-linear gain value and the third non-linear gain value may be determined by the following equations (4) and (5)

$$B = x 1 * v \hat{} 3 + x 2 * v \hat{} 2 + x 3 * v + x 4 \qquad ( 4 )$$

$$C = y 1 * v \hat{} 3 + y 2 * v \hat{} 2 + y 3 * v + y 4 \qquad ( 5 )$$

B and C are second non-linear gain value and the third non-linear gain value respectively. The constants x1, x2, x3, x4, y1, y2, y3, and y4 are dependent on the speed of the vehicle 100, weight of the vehicle 100, layout of the vehicle 100, mass-distribution of the vehicle 100. Therefore, the present subject matter provides both power assistance (transient running or steady cornering states) and balance assistance (straight running state).

The present subject matter provides improved riding experience to the riders by providing steering assistance to the vehicles. In the present subject matter, the vehicles, such as two-wheelers, can be balanced even at low-speeds without much effort from the rider. Therefore, the riders can comfortably ride in different riding conditions, such as straight running state, transient running state, and steady cornering state. The present subject matter can provide balancing assistance to the vehicle, in conditions where the vehicle is riding in a straight line and power assistance to the vehicle in conditions where the vehicle is riding in transient running state or steady cornering state. Further, the present subject matter reduces fatigue of the rider while driving the vehicle at low-speeds and prevents rolling of the vehicle due to instability.

In the present subject matter, a gear box assembly is provided to enhance the torque provided by the electric motor to the steering assembly of the vehicle. Therefore, the present subject matter provides steering assistance to the vehicles without the usage of heavy and expensive electric motors. In the present subject matter, the actuator assembly is disposed in the vehicle such that there is minimal or no impact on dynamics of the two-wheeler. Further, the torque provided by the rider on the steering assembly while riding the vehicle is taken into account while providing steering assistance to the vehicle. Therefore, the present subject matter eliminates the scenarios where the torque provided by the rider on the steering assembly and the torque provided by the actuator assembly interferes with each other, and thereby, providing excess torque than that is required to balance the steering assembly of the vehicle. Accordingly, the present subject matter prevents rolling over of the vehicle or instability of the vehicle caused due to excess torque being applied on the steering assembly due to such scenarios.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

1-28. (canceled)

29. A system for providing steering assistance in a vehicle, the system comprising:
an actuator assembly comprising an electric motor to provide torque to a steering assembly of the vehicle; and
an Electronic Control Unit (ECU) electronically coupled to the electric motor, wherein
the ECU is to:
determine whether the vehicle is in one of a straight running state, a transient running state, and a steady cornering state,
send a first control signal to the electric motor to set torque of the electric motor to a first value based on the determination that the vehicle is in one of the transient running state and the steady cornering state, wherein the first value is dependent on a first non-linear gain value and a steering torque of the vehicle, the steering torque corresponds to torque that is being applied on a steering assembly of the vehicle by a rider, the first non-linear gain value is dependent on speed of the vehicle, weight of the vehicle, layout of the vehicle, mass-distribution of the vehicle, the steering torque, and an estimated steering torque, and the estimated steering torque is a torque that is to be applied on the steering assembly of the vehicle to balance the vehicle, and
send a second control signal to the electric motor to set torque of the electric motor to a second value based on the determination that the vehicle is in the straight running state, wherein the second value is dependent on a second non-linear gain value, a third non-linear gain value, an angular displacement of the vehicle, and an angular velocity of the vehicle, and the second non-linear gain value and the third non-linear gain value are dependent on a speed of the vehicle, weight of the vehicle, layout of the vehicle, mass-distribution of the vehicle.

30. The system as claimed in claim 29, wherein prior to sending the first control signal to the electric motor, the transient running state, and the steady cornering state, the ECU is to:
estimate the first value as a product of the first non-linear gain value and the steering torque, and
send the first control signal to the electric motor to set torque of the electric motor to the first value based on the determination that the vehicle is in one of the transient running state and the steady cornering state.

31. The system as claimed in claim 29, wherein
the angular displacement of the vehicle is a roll angle of the vehicle,
the roll angle is an angular displacement in a longitudinal direction of the vehicle,
the angular velocity of the vehicle is a roll rate of the vehicle, and
the roll rate is an angular velocity in the longitudinal direction of the vehicle.

32. The system as claimed in claim 31, wherein prior to sending the second control signal, the ECU is to:
estimate the second value, wherein the second value is a sum of product of the second non-linear gain value and the roll rate of the vehicle and a product of the third non-linear gain value and the roll angle of the vehicle, and
send the second control signal to the electric motor to set torque of the electric motor to the second value based on the determination that the vehicle is in the straight running state.

33. The system as claimed in claim 31, wherein
to determine whether the vehicle is in one of the straight running state, the transient running state, and the steady cornering state, the ECU is to:
compare the roll angle with a threshold roll angle, and
compare steering angle of the steering assembly with a threshold steering angle of the steering assembly, and
based on the comparison, the ECU is to determine that:
the vehicle is in the straight running state when the roll angle is less that threshold roll angle and the steering angle of the steering assembly is less than the threshold steering angle of the steering assembly, and
the vehicle is in one of the transient running state and the steady cornering state when the roll angle is greater that threshold roll angle and the steering angle of the steering assembly is greater than the threshold steering angle of the steering assembly.

34. The system as claimed in claim 29, wherein upon the determination that the vehicle is in one of the transient running state and the steady cornering state, the ECU is to:
compare the steering torque of the vehicle with a threshold steering torque of the vehicle,
send the first control signal to the electric motor, when the steering torque is greater than the threshold steering torque, and
send a third control signal to the electric motor to set torque of the electric motor to zero, when the steering torque is less than the threshold steering torque.

35. The system as claimed in claim 29, wherein prior to sending the first control signal, the ECU is to:
determine the estimated steering torque to be supplied to the steering assembly of the vehicle, and
send the first control signal to the electric motor to set torque of the electric motor to the first value based on the determination that the vehicle is in one of the transient running state and the steady cornering state, wherein the first value is dependent on the first non-linear gain value and the steering torque of the vehicle.

36. The system as claimed in claim 29, wherein
the angular displacement of the vehicle is a roll angle of the vehicle,
the roll angle is an angular displacement in a longitudinal direction of the vehicle,
the angular velocity of the vehicle is a roll rate of the vehicle,
the roll rate is an angular velocity in the longitudinal direction of the vehicle, and
the system comprises:
a first sensor to determine the roll angle and the roll rate of the vehicle;
a second sensor to determine the steering torque of the vehicle;
a third sensor to determine a steering angle of the vehicle;
a fourth sensor to determine the speed of the vehicle; and
a fifth sensor to determine a position of the electric motor of the vehicle.

37. The system as claimed in claim 36, wherein:
the first sensor is an inertial measurement unit (IMU) sensor,
the first sensor is connected to a frame of the vehicle,
the second sensor is one of a steering angle sensor and a steering torque sensor,
the third sensor is other of the steering angle sensor and the steering torque sensor,
the second sensor is connected to a steering column of the steering assembly,
the fifth sensor is a potentiometer, and
the fifth sensor is coupled to the electric motor.

38. The system as claimed in claim 29, comprising:
a second sensor to determine the steering torque of the vehicle; and
a third sensor to determine a steering angle of the vehicle, wherein
the actuator assembly comprises a gear box assembly comprising:
a housing formed by a first casing and a second casing defining a volume;
a drive gear rotatably supported by the housing, wherein the drive gear is coupled with the electric motor;
a driven gear meshed with the drive gear, wherein the driven gear is coupled with a handle bar of steering assembly; and
a tandem gear rotatable with the driven gear and engaging with a steering angle sensor to provide steering angle of at least one of the electric motor and a steering column, and
gear ratio of the drive gear and the driven gear are to provide enhancement to the torque of the electric motor to drive a steering column of the steering assembly.

39. The system as claimed in claim 38, wherein
the electric motor is disposed parallel to an axis passing through a centre of a steering column of the vehicle, and
an axis of rotation of the drive gear is parallel to an axis of rotation of the driven gear.

40. A vehicle comprising:
a steering assembly to manoeuvre the vehicle;
a system for providing steering assistance in a vehicle, the system comprising an actuator assembly comprising an electric motor to provide torque to the steering assembly of the vehicle; and
an Electronic control Unit (ECU) electronically coupled to the electric motor, wherein
the ECU is to:
determine whether the vehicle is in one of a straight running state, a transient running state, and a steady cornering state,
send a first control signal to the electric motor to set torque of the electric motor to a first value based on the determination that the vehicle is in one of the transient running state and the steady cornering state, wherein the first value is dependent on a first non-linear gain value and a steering torque of the vehicle, the steering torque corresponds to torque that is being applied on the steering assembly of the vehicle by a rider, the first non-linear gain value is dependent on speed of the vehicle, weight of the vehicle, layout of the vehicle, mass-distribution of the vehicle, the steering torque, and an estimated steering torque, and the estimated steering torque is a torque that is to be applied on the steering assembly of the vehicle to balance the vehicle, and
send a second control signal to the electric motor to set torque of the electric motor to a second value based on the determination that the vehicle is in the straight running state, wherein the second value is dependent on a second non-linear gain value, a third non-linear gain value, an angular displacement of the vehicle, and an angular velocity of the vehicle, and the second non-linear gain value and the third non-linear gain value are dependent on a speed of the vehicle, weight of the vehicle, layout of the vehicle, mass-distribution of the vehicle.

41. The vehicle as claimed in claim 40, wherein prior to sending the first control signal to the electric motor, the transient running state, and the steady cornering state, the ECU is to:
estimate the first value as a product of the first non-linear gain value and the steering torque, and
send the first control signal to the electric motor to set torque of the electric motor to the first value based on the determination that the vehicle is in one of the transient running state and the steady cornering state.

42. The vehicle as claimed in claim 40, wherein
the angular displacement of the vehicle is a roll angle of the vehicle,
the roll angle is an angular displacement in a longitudinal direction of the vehicle,
the angular velocity of the vehicle is a roll rate of the vehicle, and
the roll rate is an angular velocity in the longitudinal direction of the vehicle.

43. The vehicle as claimed in claim 42, wherein prior to sending the second control signal, the ECU is to:
estimate the second value, wherein the second value is a sum of product of the second non-linear gain value and the roll rate of the vehicle and a product of the third non-linear gain value and the roll angle of the vehicle, and send the second control signal to the electric motor to set torque of the electric motor to
the second value based on the determination that the vehicle is in the straight running state.

44. The vehicle as claimed in claim 42, wherein
to determine whether the vehicle is in one of the straight running state, the transient running state, and the steady cornering state, the ECU is to:
compare the roll angle with a threshold roll angle, and
compare steering angle of the steering assembly with a threshold steering angle of the steering assembly, and
based on the comparison, the ECU is to determine that:
the vehicle is in the straight running state when the roll angle is less that threshold roll angle and the steering angle of the steering assembly is less than the threshold steering angle of the steering assembly, and
the vehicle is in one of the transient running state and the steady cornering state when the roll angle is greater that threshold roll angle and the steering angle of the steering assembly is greater than the threshold steering angle of the steering assembly.

45. The vehicle as claimed in claim 40, wherein upon the determination that the vehicle is in one of the transient running state and the steady cornering state, the ECU is to:
compare the steering torque of the vehicle with a threshold steering torque of the vehicle,
send the first control signal to the electric motor, when the steering torque is greater than the threshold steering torque, and
send a third control signal to the electric motor to set torque of the electric motor to zero, when the steering torque is less than the threshold steering torque.

46. The vehicle as claimed in claim 40, wherein prior to sending the first control signal, the ECU is to:
determine the estimated steering torque to be supplied to the steering assembly of the vehicle, and
send the first control signal to the electric motor to set torque of the electric motor to the first value based on the determination that the vehicle is in one of the transient running state and the steady cornering state, wherein the first value is dependent on the first non-linear gain value and the steering torque of the vehicle.

47. The vehicle as claimed in claim 40, wherein
the angular displacement of the vehicle is a roll angle of the vehicle,
the roll angle is an angular displacement in a longitudinal direction of the vehicle,
the angular velocity of the vehicle is a roll rate of the vehicle,
the roll rate is an angular velocity in the longitudinal direction of the vehicle, and
the system comprises:
a first sensor to determine the roll angle and the roll rate of the vehicle;
a second sensor to determine the steering torque of the vehicle;
a third sensor to determine a steering angle of the vehicle;
a fourth sensor to determine the speed of the vehicle; and
a fifth sensor to determine a position of the electric motor of the vehicle.

48. The vehicle as claimed in claim 47, comprising
a frame to structurally support load of the vehicle, wherein
the steering assembly comprises a steering column to control movement of a wheel of the vehicle,
the first sensor is an inertial measurement unit (IMU) sensor,
the first sensor is connected to the frame of the vehicle,
the second sensor is one of a steering angle sensor and a steering torque sensor,
the third sensor is other of the steering angle sensor and the steering torque sensor,
the second sensor is connected to the steering column of the steering assembly,
the fifth sensor is a potentiometer, and
the fifth sensor is coupled to the electric motor.

49. The vehicle as claimed in claim 40, comprising:
a second sensor to determine the steering torque of the vehicle; and
a third sensor to determine a steering angle of the vehicle, wherein
the actuator assembly comprises a gear box assembly comprising:
a housing formed by a first casing and a second casing defining a volume;
a drive gear rotatably supported by the housing, wherein the drive gear is coupled with the electric motor;
a driven gear meshed with the drive gear, wherein the driven gear is coupled with a handle bar of steering assembly; and
a tandem gear rotatable with the driven gear and engaging with a steering angle sensor to provide the steering angle of at least one of the electric motor and a steering column of the steering assembly, and
gear ratio of the drive gear and the driven gear are to provide enhancement to the torque of the electric motor to drive the steering column of the steering assembly.

50. The vehicle as claimed in claim 49, wherein
the steering assembly comprises a steering column to control steering of the vehicle,
the electric motor is disposed parallel to an axis passing through a centre of the steering column, and
an axis of rotation of the drive gear is parallel to an axis of rotation of the driven gear.

51. A method for providing steering assistance in a vehicle, the method comprising:
determining, by an electronic control unit (ECU) of the vehicle, whether the vehicle is in one of a straight running state, a transient running state, and a steady cornering state;
sending, by the ECU, a first control signal to an electric motor to set torque of the electric motor to a first value based on the determination that the vehicle is in one of the transient running state and the steady cornering state, wherein the first value is dependent on a first non-linear gain value and a steering torque of the vehicle, the steering torque corresponds to torque applied on a steering assembly of the vehicle, the first non-linear gain value is dependent on speed of the vehicle, weight of the vehicle, layout of the vehicle, mass-distribution of the vehicle, the steering torque, and an estimated steering torque, and the estimated steering torque is a torque that is to be applied on the steering assembly of the vehicle to balance the vehicle; and
sending, by the ECU, a second control signal to the electric motor to set torque of the electric motor to a second value based on the determination that the vehicle is in the straight running state, wherein the second value is dependent on a second non-linear gain value, a third non-linear gain value, an angular displacement of the vehicle in a longitudinal direction of the vehicle, and an angular velocity of the vehicle in the longitudinal direction, the second non-linear gain value and the third non-linear gain value are dependent on speed of the vehicle, weight of the vehicle, layout of the vehicle, mass-distribution of the vehicle, and the vehicle comprises an actuator assembly comprising the electric motor to provide torque to the steering assembly of the vehicle.

52. The method as claimed in claim 51, wherein prior to sending the first control signal to the electric motor, the method comprises:
estimating, by the ECU, the first value as a product of the first non-linear gain value and the steering torque; and
sending, by the ECU, the first control signal to the electric motor to set torque of the electric motor to the first value based on the determination that the vehicle is in one of the transient running state and the steady cornering state.

53. The method as claimed in claim 51, wherein
the angular displacement of the vehicle is a roll angle of the vehicle,
the roll angle is an angular displacement in a longitudinal direction of the vehicle,
the angular velocity of the vehicle is a roll rate of the vehicle,
the roll rate is an angular velocity in the longitudinal direction of the vehicle, and
prior to sending the second control signal, the method comprises:
estimating, by the ECU, the second value, wherein the second value is a sum of product of the second non-linear gain value and the roll rate of the vehicle and a product of the third non-linear gain value and the roll angle of the vehicle; and
sending, by the ECU, the second control signal to the electric motor to set torque of the electric motor to the second value based on the determination that the vehicle is in the straight running state.

54. The method as claimed in claim 51, wherein
the angular displacement of the vehicle is a roll angle of the vehicle,
the roll angle is an angular displacement in a longitudinal direction of the vehicle,
the angular velocity of the vehicle is a roll rate of the vehicle,
the roll rate is an angular velocity in the longitudinal direction of the vehicle, and
to determine whether the vehicle is in one of the straight running state, the transient running state, and the steady cornering state, method comprises:
comparing, by the ECU, the roll angle with a threshold roll angle;
comparing, by the ECU, steering angle of the steering assembly with a threshold steering angle of the steering assembly;
determining, by the ECU, the vehicle is in the straight running state when the roll angle is less that threshold roll angle and the steering angle of the steering assembly is less than the threshold steering angle of the steering assembly; and
determining, by the ECU, the vehicle is in one of the transient running state and the steady cornering state when the roll angle is greater that threshold roll angle and the steering angle of the steering assembly is greater than the threshold steering angle of the steering assembly.

55. The method as claimed in claim 51, wherein upon the determination that the vehicle is in one of the transient running state and the steady cornering state, the method comprises:
comparing, by the ECU, the steering torque of the vehicle with a threshold steering torque of the vehicle;
sending, by the ECU, the first control signal to the electric motor, when the steering torque is greater than the threshold steering torque; and
sending, by the ECU, a third control signal to the electric motor to set torque of the electric motor to zero, when the steering torque is less than the threshold steering torque.

56. The method as claimed in claim 51, wherein prior to sending the first control signal, the method comprises:
determining, by the ECU, the estimated steering torque to be supplied to the steering assembly of the vehicle; and
sending, by the ECU, the first control signal to the electric motor to set torque of the electric motor to the first value based on the determination that the vehicle is in one of the transient running state and the steady cornering state, wherein the first value is dependent on the first non-linear gain value and the steering torque of the vehicle.
